(19) United States
(12) Patent Application Publication
(10) Pub. No.: US 2025/0070345 A1
(43) Pub. Date: Feb. 27, 2025

(54) ALKALINE BATTERY

(71) Applicant: Panasonic Intellectual Property Management Co., Ltd., Kadoma-shi, Osaka (JP)

(72) Inventors: Yasufumi Takahashi, HYOGO KEN (JP); Masanobu Takeuchi, HYOGO KEN (JP)

(73) Assignee: Panasonic Intellectual Property Management Co., Ltd., Kadoma-shi, Osaka (JP)

(21) Appl. No.: 18/722,053

(22) PCT Filed: Dec. 20, 2022
(86) PCT No.: PCT/JP2022/046945

§ 371 Date: Jun. 20, 2024

(30) Foreign Application Priority Data
Dec. 22, 2021 (JP) 2021-208675

(51) Int. Cl. H01M 50/193; H01M 4/02; H01M 4/06; H01M 4/24; H01M 6/06; H01M 50/107

(52) U.S. Cl. CPC H01M 50/193; H01M 4/06; H01M 4/244; H01M 6/06; H01M 50/107; H01M 2004/027

(57) ABSTRACT

An alkaline dry battery includes: a bottomed cylindrical case; a hollow cylindrical positive electrode inscribed in the case; a negative electrode filled in a hollow part of the positive electrode and including a negative electrode active material containing zinc; a separator disposed between the positive and negative electrodes; an alkaline electrolytic solution; and a sealing unit. The alkaline electrolytic solution is contained in the positive and negative electrodes, and the separator. The sealing unit covers an opening of the case and includes a negative electrode current collector, a portion of the negative electrode current collector being inserted into the negative electrode. An additive is packed in a gap between the negative electrode and the sealing unit. The additive includes a wax component having a melting point of 60° C. or more and 110° C. or less. The wax component being an aliphatic hydrocarbon compound and/or an ester compound.

### TECHNICAL FIELD

The present disclosure relates to an alkaline dry battery.

### BACKGROUND ART

Alkaline dry batteries (alkaline-manganese dry batteries) are widely used because of their higher capacities and larger current outputs.

Patent Literature 1 proposes an alkaline battery including a positive electrode mixture and a gelled negative electrode mixture accommodated in a bottomed tubular positive electrode can, with a separator interposed between the electrode mixtures, wherein a hole portion located at a central part of a bottom of the separator is blocked with an isolation material, to separate the gelled negative electrode mixture and the bottom of the positive electrode can from each other. The isolation material is made of a thermoplastic resin melt-softens to unblock the hole portion during a process of temperature increase due to heat generation caused by shorting outside of the batter. As a result of the melt-softening of the thermoplastic resin, an internal short circuit path connecting the gelled negative electrode mixture and the bottom of the positive electrode can is formed.

### CITATION LIST

### Patent Literature

Patent Literature 1: Japanese Laid-Open Patent Publication No. 2009-283207

### SUMMARY OF INVENTION

### Technical Problem

For alkaline dry batteries, there is a need to provide enhanced safety by suppressing an increase in temperature during an external short circuit.

### Solution to Problem

An aspect of the present disclosure relates to an alkaline dry battery, including: a bottomed cylindrical case; a hollow cylindrical positive electrode inscribed in the case; a negative electrode filled in a hollow part of the positive electrode and including a negative electrode active material containing zinc; a separator disposed between the positive electrode and the negative electrode; an alkaline electrolytic solution contained in the positive electrode, the negative electrode, and the separator, and a sealing unit covering an opening of the case and including a negative electrode current collector, a portion of the negative electrode current collector being inserted into the negative electrode, wherein an additive is packed in a gap between the negative electrode and the sealing unit, the additive includes a wax component having a melting point of 60° C. or more and 110° C. or less, and the wax component includes at least one selected from the group consisting of an aliphatic hydrocarbon compound and an ester compound.

Another aspect of the present disclosure relates to an alkaline dry battery, including: a bottomed cylindrical case; a hollow cylindrical positive electrode inscribed in the case; a negative electrode filled in a hollow part of the positive electrode and including a negative electrode active material containing zinc; a separator disposed between the positive electrode and the negative electrode; an alkaline electrolytic solution contained in the positive electrode, the negative electrode, and the separator; and a sealing unit covering an opening of the case and including a negative electrode current collector, a portion of the negative electrode current collector being inserted into the negative electrode, wherein an additive is packed in a gap between the negative electrode and the sealing unit, the additive includes a wax component having an endothermic onset temperature of 50° C. or more and 85° C. or less in differential scanning calorimetry, and the wax component includes at least one selected from the group consisting of an aliphatic hydrocarbon compound and an ester compound.

### Advantageous Effects of Invention

According to the present disclosure, it is possible to suppress an increase in temperature in an alkaline dry battery during an external short circuit.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 A front view, partly in cross section, of an alkaline dry battery according to an embodiment of the present disclosure.

FIG. 2 A front view, partly in cross section, of an alkaline dry battery of Comparative Example 2.

### DESCRIPTION OF EMBODIMENTS

In the following, embodiments of the present disclosure will be described by way of examples. However, the present disclosure is not limited to the examples described below. Although examples of specific numerical values and materials may be given in the following description, other numerical values and materials may be used as long as the effects of the present disclosure can be achieved. In the present specification, the expression “from a numerical value A to a numerical value B” includes the numerical value A and the numerical value B, and can be read as “a numerical value A or more and a numerical value B or less”. In the following description, when examples of the lower and upper limits of numerical values related to a specific physical property, condition, or the like are given, any one of the given examples of the lower limit and any one of the given examples of the upper limit can be freely combined as long as the lower limit is not equal to or not greater than the upper limit. When a plurality of materials are given as examples, one of the materials may be selected and used alone, or two or more of the materials may be used in combination.

An alkaline dry battery according to an embodiment of the present disclosure includes a bottomed cylindrical case, a hollow cylindrical positive electrode inscribed in the case, a negative electrode filled in a hollow part of the positive electrode, a separator disposed between the positive electrode and the negative electrode, an alkaline electrolytic solution, and a sealing unit covering an opening of the case. The negative electrode includes a negative electrode active material containing zinc. The alkaline electrolytic solution is contained in the positive electrode, the negative electrode, and the separator. The sealing unit includes a negative electrode current collector, a portion of the negative electrode current collector being inserted into the negative electrode. An additive is packed in a gap between the negative electrode and the sealing unit. The additive includes a wax component having a melting point of 60° C. or more and 110° C. or less (or a wax component having an endothermic onset temperature of 50° C. or more and 85° C. or less in differential scanning calorimetry). The wax component includes at least one selected from the group consisting of an aliphatic hydrocarbon compound and an ester compound.

Note that the above-described melting point refers to a value measured using a typical method described, for example, in Japanese Industrial Standards (JIS K 0064). If necessary, the melting point may be a value measured using the thermogravimetry-differential thermal analysis (TG/DTA).

When the battery temperature is increased due to an external short circuit, the wax component starts to melt. Following the melting of the wax component, heat resulting from the external short circuit is absorbed, thus suppressing an increase in temperature during the external short circuit. A portion of the negative electrode current collector is exposed in a gap between the negative electrode and the sealing unit. Since the negative electrode current collector is likely to generate heat during an external short circuit, filling the additive in the gap enables an endothermic effect associated with melting of the wax component to be efficiently exerted on the negative electrode current collector, thus sufficiently suppressing an increase in the battery temperature. Preferably, the additive is packed in the gap so as to be in direct contact with the negative electrode current collector.

An amount of the wax component necessary to suppress an increase in temperature during an external short circuit can be packed in the gap. Since the additive is packed in the gap between the negative electrode and the sealing unit, the filling of the additive hardly affects the discharge performance.

The wax component having a melting point of 60° C. or more and 110° C. or less (or the wax component having an endothermic onset temperature of 50° C. or more and 85° C. or less in differential scanning calorimetry) is present as a solid during normal use (storage) of the battery and starts to melt in the event of an external short circuit. While the wax component is present as a sold in the battery, the diffusion of the wax component into the negative electrode is suppressed, so that the packing of the wax component does not affect the discharge performance. The melting point of the wax component may be 65° C. or more (or 70° C. or more) and 100° C. or less.

If the melting point of the wax component is less than 60° C. or greater than 110° C., the wax component does not sufficiently melt during an external short circuit, so that an endothermic effect resulting from the melting of the wax component may not be sufficiently exerted on the heat generated by the negative electrode current collector during the external short circuit. If the melting point of the wax component is less than 60° C., the wax component may be diffused in the negative electrode during normal use of the battery, thus affecting the discharge performance.

The above-described wax component has an endothermic onset temperature TA of preferably 50° C. or more and 85° C. or less, and more preferably 55° C. or more and 85° C. or less, in differential scanning calorimetry (DSC). In this case, an endothermic effect resulting from the melting of the wax component is efficiently exerted on the heat generated by the negative electrode current collector during an external short circuit, so that an increase in temperature during an external short circuit is likely to be suppressed.

The wax component has a peak temperature of a maximum endothermic peak in DSC of, for example, 65° C. or more and 90° C. or less. The peak temperature can be determined from a DSC curve, which is obtained in the manner described below.

The endothermic onset temperature TA can be determined as follows.

A DSC curve of the wax component is obtained using a differential scanning calorimeter. The measurement conditions may include, for example, a measurement temperature range of 0° C. to 150° C., a temperature increasing rate of 10° C./min, and a measurement atmosphere of nitrogen. As the differential scanning calorimeter, it is possible to use, for example, a “DSC-60 Plus series” manufactured by SHIMADZU CORPORATION. The temperature at a point A at which the DSC curve departs from a baseline B on the low temperature side and the heat flow (mW) starts to decrease toward an endothermic peak P is determined as the endothermic onset temperature TA. Note that the vertical axis and the horizontal axis of a graph showing a DSC curve represent the heat flow (mW) and the temperature (° C.), respectively. When a plurality of endothermic peaks appear, the above-described endothermic peak P refers to the endothermic peak appearing on the lowest temperature side.

The wax component includes at least one selected from the group consisting of an aliphatic hydrocarbon compound and an ester compound. For example, gas chromatography-mass spectrometry (GC-MS), proton nuclear magnetic resonance spectroscopy (¹H-NMR), or the like is used for the component analysis of the wax component.

The aliphatic hydrocarbon compound includes a linear saturated aliphatic hydrocarbon compound, a branched saturated aliphatic hydrocarbon compound, an alicyclic saturated aliphatic hydrocarbon compound, and the like. The number of carbon atoms in the aliphatic hydrocarbon compound is 20 or more and 60 or less, for example. The aliphatic hydrocarbon compounds may be used alone, or in combination of two or more thereof.

The ester compound includes a fatty acid ester compound, a hydroxy acid ester compound, and the like. The fatty acid ester compound includes a condensation reaction product of a higher fatty acid and a higher alcohol. The number of carbon atoms in the higher fatty acid is 6 to 40, for example. The number of carbon atoms in the higher alcohol is 10 to 30, for example. The hydroxy acid ester compound includes a condensation reaction product of a hydroxy acid and a higher alcohol. The number of carbon atoms in the hydroxy acid is 6 to 40, for example. The number of carbon atoms in the higher alcohol is 10 to 30, for example. The ester compounds may be used alone, or in combination of two or more thereof.

The wax component may include a hydrocarbon-based (petroleum-based) wax. Examples of the hydrocarbon-based wax include a paraffin wax and a microcrystalline wax. The paraffin wax contains a linear saturated aliphatic hydrocarbon compound. The number of carbon atoms in the hydrocarbon compound contained in the paraffin wax is 20 to 50, for example. The microcrystalline wax contains a branched saturated aliphatic hydrocarbon compound and a cyclic saturated aliphatic hydrocarbon compound. The number of carbon atoms in the hydrocarbon compound contained in the microcrystalline wax is 30 to 60, for example. The hydrocarbon-based waxes may be used alone, or in combination of two or more thereof.

The wax component may include an ester-based wax. The ester-based wax contains at least an ester compound, and may contain an aliphatic hydrocarbon compound (e.g., a linear aliphatic hydrocarbon compound) in addition to the ester compound. Examples of the ester-based wax include plant-based waxes such as a carnauba wax, animal-based waxes such as a Chinese wax, mineral-based waxes such as a bleached montan wax, and hydrogenated waxes (synthetic waxes) such as a hydrogenated castor oil (hydrogenated product of castor oil) (melting point: approx. 90° C.). The ester-based waxes may be used alone, or in combination of two or more thereof.

The wax component may further contain an additional component other than the aliphatic hydrocarbon compound and the ester compound. Examples of the additional component include a free fatty acid, a free alcohol, and a hydrocarbon.

The amount of the wax component filled in the battery may be 10 mg or more and 200 mg or less, or 50 mg or more and 200 mg or less, per gram of zinc derived from the negative electrode active material. When the amount of the wax component is within the above-described range, the wax component can be easily packed in a predetermined gap in the battery, and the effect of suppressing an increase in temperature during an external short circuit can be easily obtained by the wax component.

The additive contains at least the wax component. That is, only the wax component may be packed as the additive in the predetermined gap. The additive may contain an additional component other than the wax component. The additional component may be a component (e.g., polytetrafluoroethylene) that increases the binding force of a solid wax component, or may be mixed with a powdered wax component. The additive packed in the predetermined gap in the battery may be powder, a pellet, or a weld deposit on the negative electrode current collector and/or the gasket. The pellet can be obtained, for example, by compression molding a powdered wax component, or a mixture of a powdered wax component and another component. The weld deposit on the negative electrode current collector and/or the gasket can be obtained, for example, by heating the wax component to a melting point or higher, and welding the wax component to a predetermined location (portion exposed in the gap between the negative electrode and the sealing unit) of the gasket and/or the negative electrode current collector. By welding the additive to a portion where the gasket is exposed in the gap between the negative electrode and the sealing unit, the additive can be disposed close to the negative electrode current collector.

In view of the suppression of diffusion of the additive into the negative electrode and the suppression of permeation of the electrolytic solution into the additive, a thin film (e.g., cellophane) for partial shielding may be disposed between the negative electrode and the additive.

Hereinafter, an alkaline dry battery according to the present embodiment will be described in detail with reference to the drawings. Note, however, that the present disclosure is not limited to the following embodiment. In addition, modifications may be made as appropriate without departing from the scope in which the effects of the present disclosure can be achieved. Furthermore, the embodiment may be combined with other embodiments.

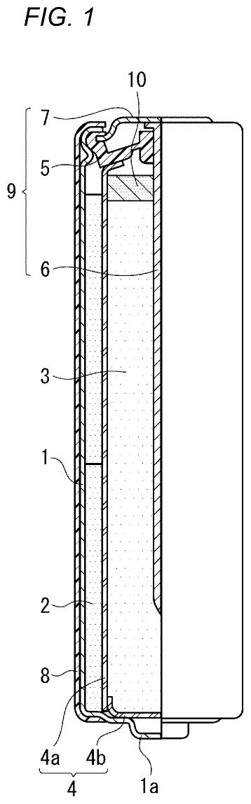

FIG. 1 is a front view of an alkaline dry battery according to an embodiment of the present disclosure, with a lateral half thereof shown in cross section. FIG. 1 shows an example of a cylindrical battery having an inside-out type structure.

As shown in FIG. 1, the alkaline dry battery includes a power generating element including a hollow cylindrical positive electrode 2, a gelled negative electrode 3 disposed inside a hollow part of the positive electrode 2, a separator 4 disposed between these electrodes, and an alkaline electrolytic solution (not shown). The power generating element is accommodated inside a bottomed cylindrical metal case 1. A protruding part 1a (positive electrode terminal part) is provided on a bottom portion of the case 1. For the case 1, a nickel plated steel plate may be used, for example. The positive electrode 2 is disposed in contact with an inner wall of the case 1. In order to increase the close contact between the positive electrode 2 and the case 1, it is preferable that an inner surface of the case 1 is coated with a carbon coating.

The bottomed cylindrical separator 4 is composed of a cylindrical separator 4a and a bottom paper 4b. The separator 4a is disposed along an inner surface of the hollow part of the positive electrode 2, and separates the positive electrode 2 and the negative electrode 3 from each other. Accordingly, the separator disposed between the positive electrode and the negative electrode means the cylindrical separator 4a. The bottom paper 4b is disposed on a bottom portion of the hollow part of the positive electrode 2, and separates the negative electrode 3 and the case 1 from each other.

An opening of the case 1 is sealed by a sealing unit 9. The sealing unit 9 includes a resin gasket 5, a negative electrode terminal plate 7 (negative electrode terminal part), and a negative electrode current collector 6. The negative electrode current collector 6 is inserted into the negative electrode 3. The negative electrode current collector 6 is made of, for example, an alloy containing copper and zinc, such as brass. If necessary, the negative electrode current collector 6 may be subjected to a plating process such as a tin plating process. The negative electrode current collector 6 has a nail shape having a head part and a shank part. The shank part of the negative electrode current collector 6 is inserted into a through hole provided in a tubular central part of the gasket 5, and the head part of the negative electrode current collector 6 is welded to a flat central part of the negative electrode terminal plate 7.

An opening end of the case 1 is crimped onto a flange part located at a circumferential edge of the negative electrode terminal plate 7, with an outer circumference end of the gasket 5 interposed therebetween. An outer surface of the case 1 is covered with an exterior label 8.

In the alkaline dry battery according to the present embodiment, an additive 10 containing a wax component is packed in a gap (gap formed by the negative electrode 3, a portion of the negative electrode current collector 6 that is exposed from the negative electrode 3, and the gasket 5) between the gelled negative electrode 3 and the sealing unit 9. Thus, an endothermic effect during the melting of the wax component contained in the additive 10 can be efficiently exerted on heat generated by the negative electrode current collector 6 during an external short circuit. In order to reliably separate the positive electrode 2 and the negative electrode 3 from each other, an end of the separator 4a located on the opening side of the case 1 is disposed so as to protrude beyond end faces of the positive electrode 2 and the negative electrode 3 located on the opening side of the case 1, and the end usually extends to a position abutting against the sealing unit 9 (gasket 5) disposed in the opening of the case 1. More specifically, the gap between the negative electrode 3 and the sealing unit 9 can be considered as a space surrounded by the negative electrode 3, the sealing unit 9 (negative electrode current collector 6 and gasket 5), and the separator 4a.

The additive 10 may be packed in the form of a ring-shaped pellet containing the wax component. In this case, the shank part of the negative electrode current collector 6 is disposed in a hollow part of the pellet. This allows the additive 10 to be stably disposed inside the gap. In view of the suppression of diffusion of the additive into the negative electrode and the suppression of permeation of the electrolytic solution contained in the negative electrode permeating into the additive, it is preferable that the additive 10 is packed in the form of a pellet. Since the separator 4a located adjacent to the additive 10 retains the electrolytic solution, the electrolytic solution contained in the separator 4a is less likely to permeate into the additive 10.

In view of the suppression of diffusion of the additive into the negative electrode and the suppression of permeation of the electrolytic solution into the additive, a thin film (e.g., cellophane) for partial shielding may be disposed between the gelled negative electrode 3 and the additive 10.

The positive electrode 2 contains manganese dioxide serving as a positive electrode active material, and the electrolytic solution. As the manganese dioxide, electrolytic manganese dioxide is preferred. The manganese dioxide is used in the form of powder. From the viewpoint of easily ensuring the packing property of the positive electrode and the diffusibility of the electrolytic solution in the positive electrode, the manganese dioxide has an average particle diameter of 20 μm or more and 60 μm or less, for example. In view of the moldability and the suppression of expansion of the positive electrode, the manganese dioxide may have a BET specific surface area in the range from 20 m²/g to 50 m²/g.

In the present specification, an average particle diameter refers to a median diameter (D50) in a volume-based particle size distribution. The average particle diameter can be determined using a laser diffraction and/or scattering particle size distribution measurement device, for example. A BET specific surface area refers to a surface area measured and calculated using a BET equation, which is a theoretical equation of multilayer adsorption. The BET specific surface area can be measured using a specific surface area measurement device employing a nitrogen adsorption method.

The positive electrode 2 may contain a conductive agent in addition to the manganese dioxide and the electrolytic solution. Examples of the conductive agent include carbon black such as acetylene black, and conductive carbon materials such as graphite. Natural graphite, artificial graphite, or the like can be used as the graphite. The conductive agent may be in the form of fibers, but is preferably in the form of powder. The average particle diameter of the conductive agent can be selected from the range from 5 nm to 50 μm, for example. The average particle diameter of the conductive agent is preferably 5 nm or more and 40 nm or less for carbon black, and is preferably 3 μm or more and 50 μm or less for graphite. The content of the conductive agent in a positive electrode mixture per 100 parts by mass of the manganese dioxide is, for example, 3 parts by mass or more and 10 parts by mass or less, preferably 4 parts by mass or more and 8 parts by mass or less.

The positive electrode 2 can be obtained, for example, by compression molding a positive electrode mixture containing the positive electrode active material, the conductive agent, and the electrolytic solution into pellets. The positive electrode mixture may be formed into flakes or granules, and, if necessary, classified, and thereafter compression-molded into pellets. The pellets may be accommodated inside the case, and thereafter brought into close contact with the inner wall of the case through secondary compression using a predetermined tool. The average density of the manganese dioxide in the positive electrode pellets is 2.78 g/cm³ or more and 3.08 g/cm³ or less, for example. If necessary, the positive electrode (positive electrode mixture) may further contain another component (e.g., polytetrafluoroethylene).

The negative electrode 3 has a gel form. That is, the negative electrode 3 usually contains a gelling agent in addition to the negative electrode active material and the electrolytic solution. The negative electrode active material contains zinc or a zinc alloy. In view of the corrosion resistance, the zinc alloy preferably includes at least one selected from the group consisting of indium, bismuth, and aluminum.

Usually, the negative electrode active material is used in the form of powder. In view of the filling property of the negative electrode and the diffusibility of the alkaline electrolytic solution in the negative electrode, the negative electrode active material powder has an average particle diameter of, for example, 80 μm or more and 200 μm or less, preferably 100 μm or more and 150 μm or less. The content of the negative electrode active material powder in the negative electrode is, for example, 170 parts by mass or more and 220 parts by mass or less, per 100 parts by mass of the electrolytic solution.

As the gelling agent, any known gelling agent used in the field of alkaline dry batteries may be used without any particular limitation. For example, a water absorbent polymer can be used. Examples of such a gelling agent include polyacrylic acid and sodium polyacrylate. The amount of the gelling agent added is, for example, 0.5 parts by mass or more and 2 parts by mass or less, per 100 parts by mass of the negative electrode active material.

As the separator 4, a non-woven fabric or a microporous film can be used, for example. Examples of the material of the separator include cellulose and polyvinyl alcohol. As the non-woven fabric, it is possible to use, for example, a non-woven fabric composed mainly of fibers of any of the aforementioned materials. As the microporous film, cellophane or the like can be used. The separator has a thickness of 80 μm or more and 300 μm or less, for example. The separator may be formed by placing a plurality of sheets (of a non-woven fabric or the like) on top of another to have a thickness in the above-described range.

In FIG. 1, the bottomed cylindrical separator 4 is composed of the cylindrical separator 4a and the bottom paper 4b; however, the present disclosure is not limited thereto. A bottomed cylindrical integrated object may be used as the separator, and a separator having a known shape used in the field of alkaline dry batteries can be used.

As the electrolytic solution, an aqueous potassium hydroxide solution can be used, for example. The concentration of the potassium hydroxide in the electrolytic solution is 30 mass % or more and 50 mass % or less, for example. The electrolytic solution may further contain zinc oxide. The concentration of the zinc oxide in the electrolytic solution is 1 mass % or more and 5 mass % or less, for example.

### EXAMPLES

Hereinafter, the present disclosure will be specifically described by way of examples and comparative examples. However, the present disclosure is not limited to the following examples.

### Examples 1 to 12

An AA-size cylindrical alkaline dry battery (LR6) shown in FIG. 1 was produced according to the following procedure.

### (Production of Positive Electrode)

To electrolytic manganese dioxide powder (average particle diameter: 35 μm) serving as a positive electrode active material, graphite powder (average particle diameter: 8 μm) serving as a conductive agent was added, to obtain a mixture. The mass ratio of the electrolytic manganese dioxide powder and the graphite powder was set to 92.4:7.6. To 100 parts by mass of the mixture, 1.5 parts by mass of an electrolytic solution was added, and the mixture was stirred sufficiently and thereafter compression-molded into flakes, to obtain a positive electrode mixture. The electrolytic solution used here was an aqueous alkaline solution containing potassium hydroxide (concentration: 35 mass %) and zinc oxide (concentration: 2 mass %).

The positive electrode mixture in the form of flakes was pulverized into granules, which were then classified using a sieve of 10 to 100 mesh, and the resulting granules were compression-molded into a predetermined hollow cylindrical shape, to produce two positive electrode pellets.

### (Production of Negative Electrode)

A negative electrode active material, an electrolytic solution, and a gelling agent were mixed, to obtain a gelled negative electrode 3. The negative electrode active material used here was zinc alloy powder (average particle diameter: 130 μm) containing 0.02 mass % of indium, 0.01 mass % of bismuth, and 0.005 mass % of aluminum. The electrolytic solution used here was the same electrolytic solution as that used for producing the positive electrode. The gelling agent used here was a mixture of a cross-linked branched polyacrylic acid and a highly crosslinked linear sodium polyacrylate. The mass ratio of the negative electrode active material, the electrolytic solution, and the gelling agent was set to 100:50:1.

### (Assembly of Alkaline Dry Battery)

A carbon coating (thickness: approx. 10 μm) was formed on the inner surface of a bottomed cylindrical case (outer diameter: 13.80 mm, height: 50.3 mm) made of a nickel plated steel plate, to obtain a case 1. Two longitudinally oriented positive electrode pellets were inserted on top of the other into the case 1 and then compressed, to form a positive electrode 2 in close contact with the inner wall of the case 1. A bottomed cylindrical separator 4 was disposed inside of the positive electrode 2, and thereafter an electrolytic solution was injected thereto, to impregnate the separator 4 with the electrolytic solution. The electrolytic solution used here was the same electrolytic solution as that used for producing the positive electrode. These constituents were allowed to stand for a predetermined time, to allow the electrolytic solution to permeate from the separator 4 into the positive electrode 2.

Thereafter, a predetermined amount of a gelled negative electrode 3 was filled inside the separator 4. An additive 10 was disposed on the negative electrode 3. The additive 10 used here was a ring-shaped pellet obtained by compression molding a wax component in the form of powder. As the wax component, each of the various wax components shown in Table 1 was used. Of the various wax components, those containing an aliphatic hydrocarbon compound and/or an ester compound are marked with o in the columns of the corresponding compounds in Table 1. The packing amounts (amounts per gram of zinc derived from the negative electrode active material) of the wax components were set to the value shown in Table 1.

The separator 4 was formed using a cylindrical separator 4a and a bottom paper 4b. Each of the cylindrical separator 4a and the bottom paper 4b used here was a sheet of a mixed non-woven fabric mainly composed of rayon fibers and polyvinyl alcohol fibers at a mass ratio of 1:1. The non-woven fabric sheet used as the bottom paper 4b had a thickness of 0.27 mm. The separator 4a was formed by winding a non-woven fabric sheet having a thickness of 0.09 mm in three layers.

The negative electrode current collector 6 was obtained by pressing a typical brass (Cu content: approx. 65 mass %, Zn content: approx. 35 mass %) into a nail shape, and thereafter plating the surface of the nail-shaped brass with tin. A head part of the negative electrode current collector 6 was electrically welded to a negative electrode terminal plate 7 made of a nickel plated steel plate. Thereafter, a shank part of the negative electrode current collector 6 was press-fitted into a through hole of a resin gasket 5. In this manner, a sealing unit 9 composed of the gasket 5, the negative electrode terminal plate 7, and the negative electrode current collector 6 was produced.

Next, the sealing unit 9 was placed at the opening of the case 1. At this time, the shank part of the negative electrode current collector 6 was passed through a hollow part of the ring-shaped pellet (additive 10) and inserted into the negative electrode 3. An opening end of the case 1 was crimped onto a circumferential edge of the negative electrode terminal plate 7, with the gasket 5 interposed therebetween, to seal the opening of the case 1. The outer surface of the case 1 was covered with an exterior label 8. In this manner, an alkaline dry battery with the additive 10 packed in the gap between the negative electrode 3 and the sealing unit 9 was produced. In Table 1, A1 to A12 denote batteries of Examples 1 to 12.

### Comparative Example 1

Battery X1 of Comparative Example 1 was produced in the same manner as the battery A1 of Example 1 except that the additive 10 was not packed in the gap between the negative electrode 3 and the sealing unit 9.

### Comparative Example 2

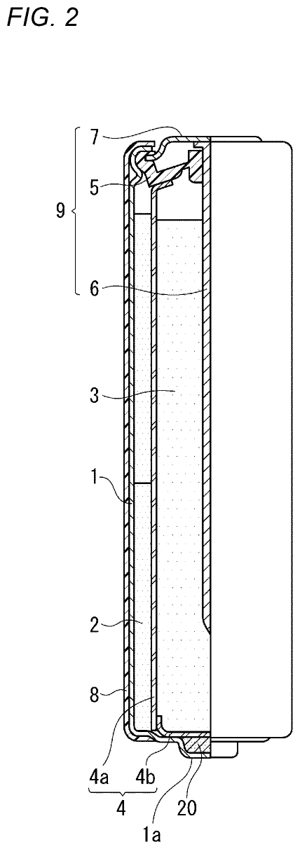

In place of the additive 10, an additive 20 was packed in a gap (void part formed by the protruding part 1a serving as a positive electrode terminal part) between the negative electrode 3 and the bottom portion of the case 1, as shown in FIG. 2. As the additive 20, a paraffin wax serving as a wax component was used. The packing amount (amount per gram of zinc derived from the negative electrode active material) of the wax component was set to 50 mg.

Except for the foregoing, battery X2 of Comparative Example 2 was produced in the same manner as the battery A1 of Example 1.

### [Evaluation]

For each of the batteries produced as above, the surface temperatures of the battery (the vicinity of the center of the case in the height direction) after causing an external short circuit were measured, and a maximum temperature at that time was determined.

The evaluation results are shown in Table 1. Note that the packing amounts shown in Table 1 are the amounts (mg) of the wax components filled per gram of zinc derived from the negative electrode active material contained in the negative electrode.

TABLE 1

| | Additive | | | | | | | Maximum |
|---|---|---|---|---|---|---|---|---|
| | | | | | Endothermic onset | | | temperature of |
| | | | | | temperature in | | | battery surface |
| | | Aliphatic | | Melting | differential scanning | Packing | | during external |
| Battery | | hydrocarbon | Ester | point | calorimetry | amount | Packing | short circuit |
| No. | Type | compound | compound | (° C.) | (° C.) | (mg) | location | (° C.) |
| A1 | bleached montan | ○ | ○ | 62 | 55 | 10 | gap between | 98 |
| | wax | | | | | | negative | |
| A2 | bleached montan | ○ | ○ | 62 | 55 | 50 | electrode | 96 |
| | wax | | | | | | and sealing | |
| A3 | bleached montan | ○ | ○ | 62 | 55 | 200 | unit | 93 |
| | wax | | | | | | | |
| A4 | paraffin wax | ○ | — | 74 | 56 | 10 | | 98 |
| A5 | paraffin wax | ○ | — | 74 | 56 | 50 | | 97 |
| A6 | paraffin wax | ○ | — | 74 | 56 | 200 | | 94 |
| A7 | Chinese wax | ○ | ○ | 86 | 78 | 10 | | 98 |
| A8 | Chinese wax | ○ | ○ | 86 | 78 | 50 | | 96 |
| A9 | Chinese wax | ○ | ○ | 86 | 78 | 200 | | 94 |
| A10 | carnauba wax | — | ○ | 85 | 82 | 50 | | 98 |
| A11 | hydrogenated | — | ○ | 88 | 83 | 50 | | 98 |
| | castor oil | | | | | | | |
| A12 | microcrystalline | ○ | — | 101 | 85 | 100 | | 97 |
| | wax | | | | | | | |
| X1 | not added | — | — | — | — | — | | 103 |
| X2 | paraffin wax | ○ | — | 74 | 56 | 50 | gap between | 102 |
| | | | | | | | negative | |
| | | | | | | | electrode and | |
| | | | | | | | bottom portion | |
| | | | | | | | of case | |

An increase in temperature during the external short circuit was suppressed more significantly in the batteries A1 to A12 than in the batteries X1 and X2.

The battery X1, in which no additive was packed, the battery temperature increased during the external short circuit.

In the battery X2, in which the additive was packed in the gap between the bottom portion of the case and the negative electrode, the additive was packed at a position away from the negative electrode current collector. Accordingly, heat generated by the negative electrode current collector during the external short circuit was not sufficiently absorbed by the additive, so that an increase in the battery temperature was not successfully suppressed.

### INDUSTRIAL APPLICABILITY

The alkaline dry battery according to the present disclosure is suitably used, for example, as a power source for a portable audio device, an electronic gaming console, a light, and the like.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

1: case, 1a: protruding part, 2: positive electrode, 3: negative electrode, 4: bottomed cylindrical separator, 4a: cylindrical separator, 4b: bottom paper, 5: gasket, 6: negative electrode current collector, 7: negative electrode terminal plate, 8: exterior label, 9: sealing unit, 10: additive

1. An alkaline dry battery, comprising:
a bottomed cylindrical case;
a hollow cylindrical positive electrode inscribed in the case;
a negative electrode filled in a hollow part of the positive electrode and including a negative electrode active material containing zinc;
a separator disposed between the positive electrode and the negative electrode;
an alkaline electrolytic solution contained in the positive electrode, the negative electrode, and the separator; and
a sealing unit covering an opening of the case and including a negative electrode current collector, a portion of the negative electrode current collector being inserted into the negative electrode, wherein
an additive is packed in a gap between the negative electrode and the sealing unit,
the additive includes a wax component having a melting point of 60° C. or more and 110° C. or less, and
the wax component includes at least one selected from the group consisting of an aliphatic hydrocarbon compound and an ester compound.

2. The alkaline dry battery according to claim 1, wherein the aliphatic hydrocarbon compound includes a linear saturated aliphatic hydrocarbon compound.

3. The alkaline dry battery according to claim 1, wherein the ester compound includes a fatty acid ester compound.

4. The alkaline dry battery according to claim 1, wherein the wax component has an endothermic onset temperature of 50° C. or more and 85° C. or less in differential scanning calorimetry.

5. The alkaline dry battery according to claim 1, wherein the wax component is included in an amount of 10 mg or more and 200 mg or less per gram of zinc derived from the negative electrode active material.

6. An alkaline dry battery, comprising:
a bottomed cylindrical case;
a hollow cylindrical positive electrode inscribed in the case;
a negative electrode filled in a hollow part of the positive electrode and including a negative electrode active material containing zinc;
a separator disposed between the positive electrode and the negative electrode;
an alkaline electrolytic solution contained in the positive electrode, the negative electrode, and the separator; and
a sealing unit covering an opening of the case and including a negative electrode current collector, a portion of the negative electrode current collector being inserted into the negative electrode, wherein
an additive is packed in a gap between the negative electrode and the sealing unit,
the additive includes a wax component having an endothermic onset temperature of 50° C. or more and 85° C. or less in differential scanning calorimetry, and
the wax component includes at least one selected from the group consisting of an aliphatic hydrocarbon compound and an ester compound.
